(19) United States
(12) Patent Application Publication
(10) Pub. No.: US 2021/0365864 A1
(43) Pub. Date: Nov. 25, 2021

(54) MENTORING TOOL

(71) Applicant: SAGEFLOW BVBA, Brisbane (AU)

(72) Inventor: Dave Vrijsen, Brisbane (AU)

(21) Appl. No.: 17/276,924

(22) PCT Filed: Sep. 19, 2018
(86) PCT No.: PCT/AU2018/051025

§ 371 Date: Mar. 17, 2021

(51) Int. Cl. G06Q 10/06; G06Q 50/20; G06F 16/9535

(52) U.S. Cl. CPC G06Q 10/06393; G06Q 10/06398; G09B 5/065; G06F 16/9535; G06Q 50/2057

(57) ABSTRACT

The present invention relates to an online mentoring tool. The tool is configured to assign a goal to be performed to a mentee at a promotional level. Further, the tool receives, from a mentor, scoring of the mentee in achieving the goal. The tool is also configured to promote the mentee to a higher promotional level using the scoring. Advantageously, the structured assigning and scoring is of benefit to the mentee during mentoring, and promotion of the mentee in this structured environment increases the perceived value of the mentee so that the mentee can gain improved access to in-demand mentors.

### TECHNICAL FIELD

The present invention generally relates to a mentoring tool to facilitate mentoring between a mentor and mentee.

### BACKGROUND

The reference to any prior art in this specification is not, and should not be taken as an acknowledgement or any form of suggestion that the prior art forms part of the common general knowledge.

Mentoring is a mutually beneficial relationship which involves a more experienced mentor helping a less experienced mentee to achieve their goals.

In practice, it can be difficult for the mentee to locate and engage a suitable mentor. The mentee in a particular area may be forced to choose from a limited number of mentors. Similarly, distance between the mentor and mentee can inhibit the conduction of mentoring sessions and increase costs.

The preferred embodiment facilitates location and engagement of a suitable mentor for regular mentoring sessions, irrespective of location.

Invariably, many mentoring relationships are informal with no tangible outcomes or benefits for the mentor or mentee.

The preferred embodiment provides for a more formal mentoring structure which benefits the mentee or mentor.

### SUMMARY OF THE INVENTION

According to one aspect of the present invention, there is provided an online mentoring method involving the steps of electronically:

assigning a goal to be performed to a mentee at a promotional level;

receiving, from a mentor, scoring of the mentee in achieving the goal; and

promoting the mentee to a higher promotional level using the scoring.

Advantageously, the structured assigning and scoring is of benefit to the mentee during mentoring, and promotion of the mentee in this structured environment increases the perceived value of the mentee so that the mentee can gain improved access to in demand mentors.

The promoting may further involve using time the mentee has spent at the promotional level and/or number of mentoring sessions between the mentor and the mentee.

The goal may include one or more tasks. The scoring may include a star rating for each task. The scoring may involve applying a weighting by the mentor according to difficulty. The scoring may involve automatically decreasing the star rating when the goal is not achieved within a specified time

The method may involve resetting a scoring of the mentee upon promotion. The method may involve displaying the promotional level and an overall rating of the mentee. The overall rating may be a moving average of the star ratings.

The method may involve receiving, from the mentee, scoring of the mentor. The method may involve promoting the mentor to a higher promotional level. The scoring from the mentor and mentee may only be received subsequent to the goal being completed.

The method may involve displaying an overall rating of the mentor to assist with promotion and perceived value of the mentor in the case of a favourable rating, or to assist with informing the mentee in the case of an unfavourable rating. The overall rating may be a moving average of star ratings from mentees the mentor has mentored.

The method may involve the mentee accepting the goal from the mentor. The method may involve the mentee search for the mentor from a number of possible mentors including criteria such as experience, industry, function, personality, location, or company.

The method may involve generate a company report including goal details relating to the mentee or other mentees that are employees of the company. The method may involve displaying one or more graphs showing percentage completion of one or more goals over time.

The method may involve holding mentoring sessions between the mentor and mentee using an inbuilt video chat tool and/or messaging.

According to another aspect of the present invention, there is provided an online mentoring tool configured to:

assign a goal to be performed to a mentee at a promotional level;

receive, from a mentor, scoring of the mentee in achieving the goal; and

promote the mentee to a higher promotional level using the scoring.

The tool may include a website or an App. The tool may be further configured to establish a relationship between the mentor and mentee.

The mentoring tool may include a searching tool to enable the mentee to search for the mentor from a number of possible mentors, irrespective of location. The mentoring tool may be configured to recommend the mentors to the mentees based upon personality.

Alternatively, the mentoring tool may be configured to recommend a mentor for engagement to the mentee based upon mentor responses and mentee responses to respective mentor compatibility queries and mentee compatibility queries. The tool may be configured to receive, from mentors, mentor responses to mentor compatibility queries. The tool may be configured to receive, from the mentee, mentee responses to mentee compatibility queries.

The recommendation may be determined using a mentor profile and a mentee profile created using the mentor responses and mentee responses respectively. The recommendation may be determined by matching parameters in the profiles, with the recommended mentor having the greatest number of matching parameters with the mentee when compared with the other mentors.

The mentoring tool may include an inbuilt video chat tool to advantageously facilitate communication during sessions between the mentor and mentee, without the need to travel to a common location.

The mentoring tool may include a company reporting tool for generating reports including goal details relating to the mentee or other mentees that are employees of the company.

The mentoring tool may include a competition tool for enabling mentors to compete with each other.

According to another aspect of the present invention, there is provided an online mentoring system including the tool, a computer of the mentee, a computer of the mentor and an administration server for administering the tool.

According to another aspect of the present invention, there is provided an online service provider engagement method involving the steps of electronically:

receiving, from service providers, service provider responses to service provider compatibility queries; and

receiving, from a client, client responses to client compatibility queries; and

recommending a service provider for engagement by the client using the service provider responses and the client responses.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of an online mentoring system in accordance with an embodiment of the present invention;

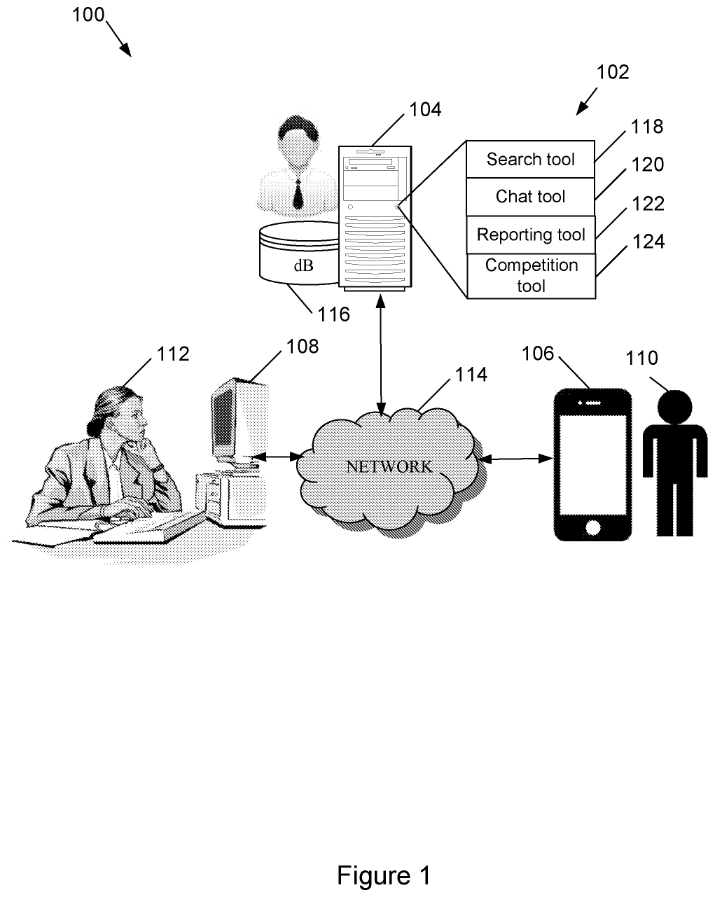

FIG. 2 is a flowchart of an online mentoring method performed using the system of FIG. 1; and

FIG. 3 is a schematic view of the searching tool of the system of FIG. 1;

FIG. 4 is a schematic view of a displayed mentor profile;

FIG. 5 is a schematic view of a displayed mentee profile;

FIG. 6 is a schematic view of a mentees goal and associated tasks; and

FIG. 7 is a schematic view of mentee statistics displayed to a mentor.

### DETAILED DESCRIPTION OF PREFERRED EMBODIMENTS

According to an embodiment of the present invention, there is provided an online mentoring system 100 including a mentoring tool 102, including a website or an App (i.e. application software). An administration server 104 includes the mentoring tool 102 and administers the online system 100.

The system 100 further includes a mentee's computer 106 and a mentor's computer 108, through which a mentee 110 and mentor 112 interact with the tool 102, and communicate with each other over a network 114 including the Internet.

The system 100 further includes a database 116 administered by the administration server 104, and storing information relating to the mentee 110 and mentor 112.

The online mentoring tool 102 is configured to assign a goal to be performed to the mentee 110 at a hierarchical promotional level. The online mentoring tool 102 also receives, from the mentor 112, scoring of the mentee 110 in achieving the goal. Finally, the online mentoring tool 102 promotes the mentee to a higher promotional level using the scoring, time the mentee has spent at the level and number of mentoring sessions between the mentor 112 and the mentee 110.

Advantageously, the structured assigning and scoring provided by the tool 102 is of benefit to the mentee 110 during mentoring, and promotion of the mentee 110 in this structured environment increases the perceived value of the mentee 110 so that the mentee 110 can gain improved access to higher level mentors 112.

The mentoring tool 102 includes a searching tool 118 to enable the mentee 110 to search for the mentor 112 from a number of possible mentors, irrespective of location of either. The mentoring tool 102 includes an inbuilt video chat tool 120 to advantageously facilitate communication during mentoring sessions between the mentor 112 and mentee 110, without the need to travel to a common location. The inbuilt chat tool 120 also includes a messaging tool to enable the mentor 112 and mentee 110 to message each other.

Further, the mentoring tool 102 includes a company reporting tool 122 for generating reports including goal details relating to the mentee 110, or other mentees that are employees of a company. The mentoring tool 102 also includes a competition tool 124 for enabling subscribed mentees 110 or mentors 112 to compete with each other. Companies are able to advantageously run their entire mentoring programme, based on exclusive corporate suites which are designed to guarantee full separation from an open platform by default but can be set as half-open, if the company allows their corporate mentees to also have mentoring relationships outside of the corporate suite.

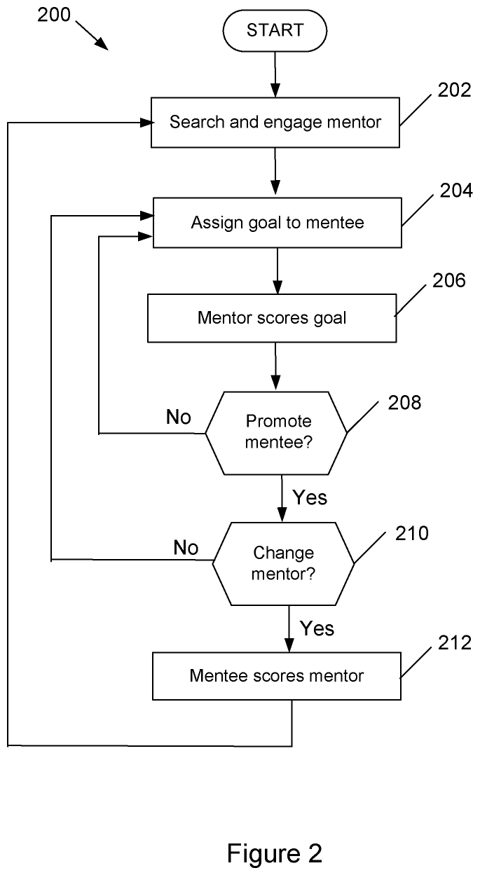

FIG. 2 shown an online mentoring method 200 performed using the tool 102. Initially, the mentor 112 and mentee 110 have subscribed to the tool 102 and opened accounts in database 116. The mentee 110 is assigned a promotional level, which is initially the lowest level if there has been no prior mentoring, or the previous level if the mentee 110 is resuming mentoring after a hiatus.

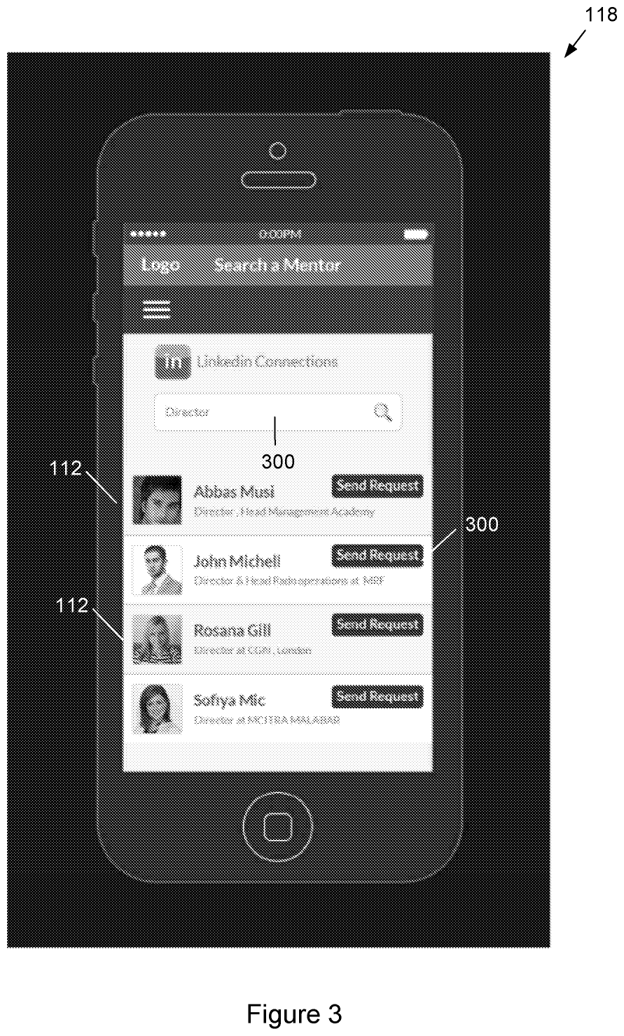

At step 202, the mentee 110 using computer 106 and searching tool 118, searches the database 116 for the mentor 112 from a number of possible mentors 112 as shown in FIG. 3. The search criteria 300 includes any one or more of: position, experience, industry, function, personality, location, and company. The mentoring tool 102 enables mentors 112 to broadcast their skills and experience to everyone subscribed to the mentoring tool 102 on the platform, without having to pay extra for this feature as long as they have the right subscription level.

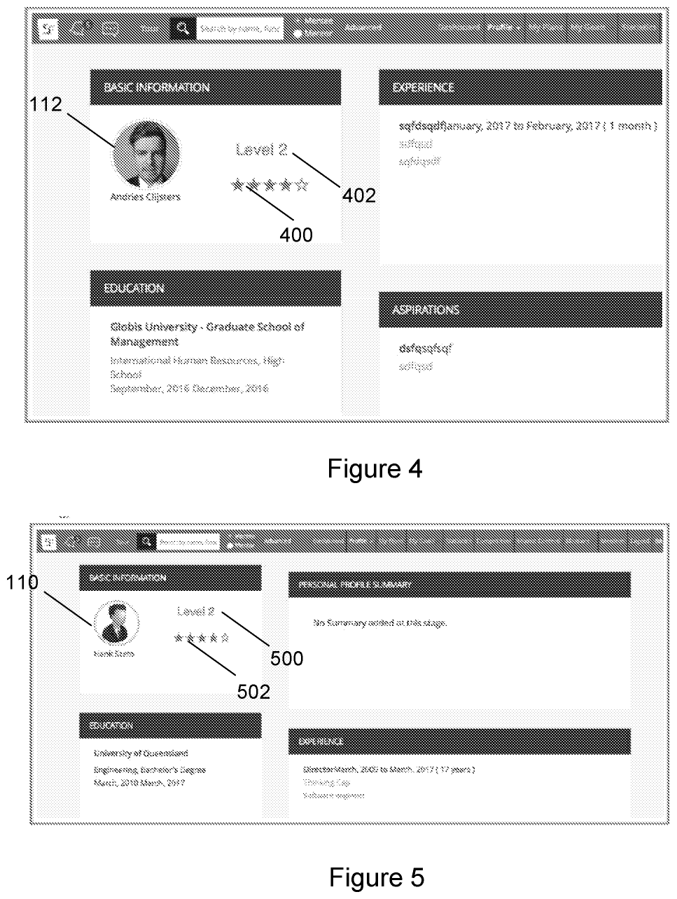

The mentee 110 can select a mentor 112 to view a displayed overall star rating 400 and promotional level 402 of the mentor 112 as shown in FIG. 4, which assists with marketing and perceived value of the mentor 112 in the case of a favourable rating 400, and which assists with informing the mentee 110 to steer clear in the case of an unfavourable rating 400. The overall rating 400 is a moving average of star ratings from mentees 110 the mentor 112 has previously mentored.

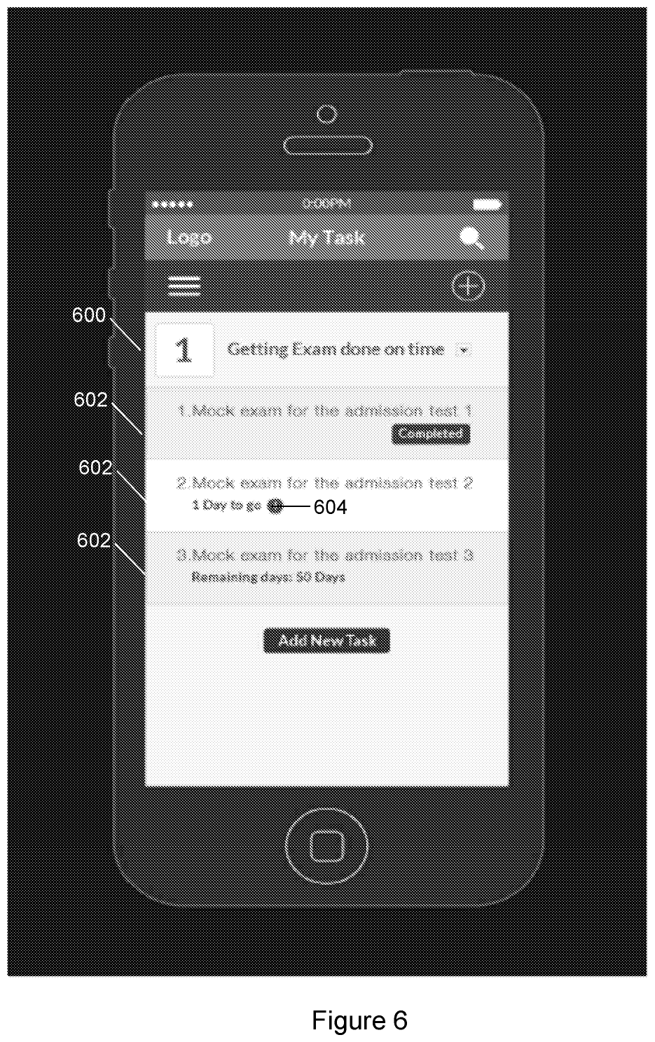

The mentee 110 engages the mentor 112 by way of an invitation 300 (FIG. 3) which is accepted to form the mentoring relationship and the details are logged in the database 116. The mentee 110 can send the invitation 300 to any mentor 112 on the platform, without restriction and irrespective of business, company, location or any other restricting factors. As can best be seen in FIG. 5, the mentor 112 can view a displayed promotional level 500 and an overall star rating 502 of the mentee 110 before deciding whether to enter into the mentoring relationship. The overall rating 502 is typically a moving average of star ratings associated with mentee goals.

The mentors 112 can charge for their time in mentoring mentees 110. Depending on the level of the mentee 110 who wants to engage with a mentor 112, the cost to do so varies. The higher the level of the mentee 110, the lower the cost to engage a higher level mentor 112. Not all mentors 112 will charge for their time, but those who do could benefit from higher scores from mentees 110, so that the mentees 110 themselves are rated higher and can charge a higher amount as mentors 112. The system 100 is fully flexible and the amount charged by the mentor 112 is set by them in order to create a self-governing ecosystem.

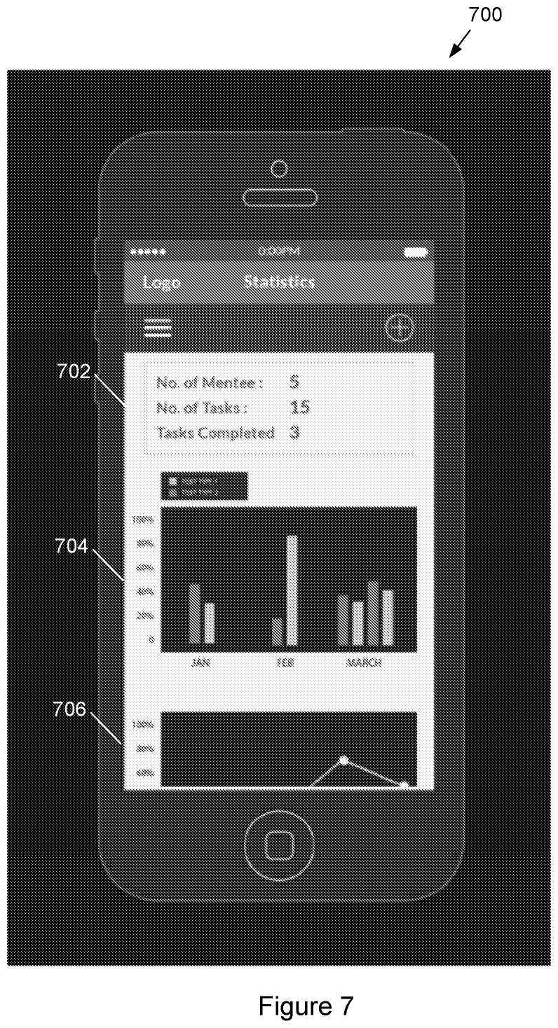

At step 204, the tool 102 assigns a goal 600 to be performed by the mentee 110 to that mentee 110 as shown in FIG. 6. The goal 600 includes one or more tasks 602 often associated with a completion deadline 604. The goal 600 can be developed by the mentor 112 and then accepted by the mentee 110, or visa versa.

The inbuilt chat tool 120 of the mentoring tool 102 is used to hold mentoring sessions between the mentor 112 and mentee 110 to discuss the progress of the goal 600 and associated tasks 602. The mentor 112 and mentee 110 can also message each other without the need to leave the mentoring tool 102 and remain on the same platform. Details of the sessions are logged in the database 116.

At step 206, the tool 102 receives, from the mentor 112, scoring of the mentee 110 in achieving the goal 600. The scoring includes a star rating for each task 602. The scoring involves applying weighting by the mentor 112 according to difficulty (e.g. easy=score×0.6, moderate=score×0.8, challenging=score by 1, hard=score by 1.2).

Furthermore, the scoring may involve automatically decreasing the star rating when the goal 600 is not achieved within a specified time. A grace period may be applied, but then the score is diminished linearly over time. Upon scoring, the goal 600 and tasks 602 cannot be changed.

At step 208, the tool 102 queries whether to promote the mentee 110 to a higher promotional level. The promotion is automatically determined using stored information in the database 116 including the scoring at step 208, time the mentee has spent at the current promotional level 500 and number of mentoring sessions between the mentor 112 and the mentee 110.

For example, FAST TRACK promotion involves:
Mentee 110 scoring in top 10% in the current promotion level 500 at end of month
Mentee 110 exceeding minimum time spent at the current promotional level 500 (e.g. minimum 2 months)
Mentee 110 has achieved minimum number of mentoring sessions with mentor 112 that month (e.g. 2)

For example, SLOW TRACK promotion involves:
Mentee 110 scoring in top 30% in the current promotion level 500 at end of 3 months
Mentee 110 exceeding minimum time spent at the current promotional level 500 (e.g. minimum 3 months) or subscribed to the system 100
Mentee 110 has achieved minimum number of mentoring sessions with mentor 112 in 3 months (e.g. 4)

If not promoted at step 208, a new goal 600 is assigned to the mentee 110 at step 204.

If promoted at step 208, the database 116 is updated to reflect the new promotional level 500 of the mentee 110, and current scoring rating 502 of the mentee 110 is reset.

At query step 210, the tool 102 receives confirmation from the mentee 110 as to whether a change of mentor 112 is required.

If no change of mentor 112 is required at step 210, a new goal 600 is assigned to the mentee 110 at step 204.

If a change of mentor 112 is required in view of the promotion at step 210, the method 200 proceeds to step 212.

At step 212, the tool 102 receives scoring of the mentor 112 from the mentee 110. The scoring typically includes a star rating 400. In a similar promotional manner to the mentee 110, the tool 102 can promote the mentor 112 to a higher promotional level 402 using an aggregate rating 400 of mentee scoring. The mentor rating is displayed on their profile.

A company representative can generate a company report including goal details relating to the mentee 110 or any other mentees that are employees of the company. All information will be available according to strict confidentiality principles built into the database 116. Advantageously, the mentoring tool provides companies with the means for mentoring specific people 110 for a specific purpose. For example, this mentoring platform or tool 102 can be used to make informed recruitment decisions. By mentoring several (e.g. 3-5) possible candidates 110 for a given role that is vacant within the company, the company has first-hand experience in working with these people 110 on a number of mentoring goals already. Both the company and mentee 110 will get a clear idea in advance of whether or not the mentee 110 would be suited to work for the mentor 112, or the company in a given role.

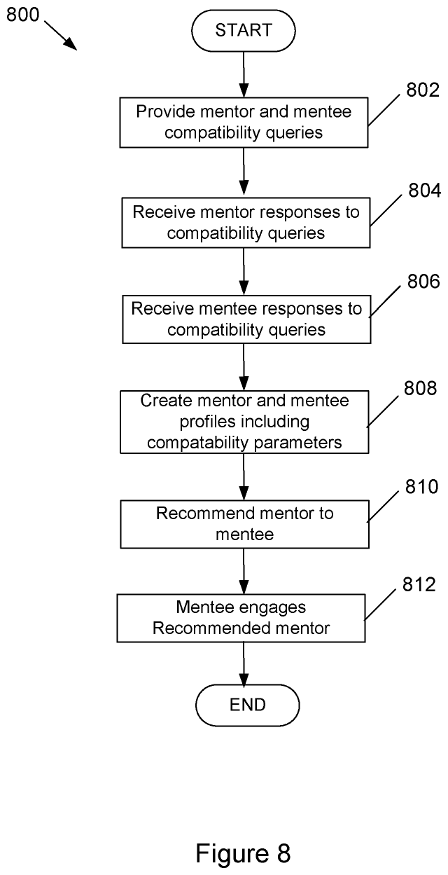

Furthermore, the mentor 112 can use the tool 102 to generate a graphical statistics report 700 for performance of the mentee 110 as shown in FIG. 7. The report 700 shows statistics 702 for the mentee 110, a first graph 704 showing percentage completion of the goal 600 over time, and a second graph 706 showing percentage completion of goals for all mentees 110 associated with the mentor 112 over time.

The competition tool 124 can award prizes to subscribed mentees 110 or mentors 112 based upon the scoring when compared with scoring of other subscribed mentees 110 or mentors 112.

A person skilled in the art will appreciate that many embodiments and variations can be made without departing from the ambit of the present invention.

For example, at step 204, the mentee 110 may be assigned with multiple goals at once.

In one embodiment, a fixed percentage of all charges made by all the mentors 112 will be donated to one or more good causes (e.g. charities). The donations are deducted automatically by the mentoring tool 102 before paying the mentors 112 for their time and efforts based on a preset agreement of percentages.

In one embodiment, the mentoring tool 102 recommends mentors 112 to mentees 110, based upon personality matches. Mentors 112 and mentees 110 complete a personality test upon registration to the system 100, which automatically analyses the tests and provides recommendations on the best possible matches. The system 100 can also combine these personality matches with other types of matches, such as industry, position, etc.

In another embodiment, the mentoring tool 102 recommends a most suitable mentor 112 (i.e. service provider) to a mentee 110 (i.e. client) in place of step 202 above. The corresponding online mentor engagement method 800 is described below in relation to FIG. 8.

Initially, at step 802, a customizable set of compatibility queries are provided by the administration server 104 to many mentors 112 and a mentee 110. The mentor compatibility queries are similar or the same to the mentee compatibility queries.

At step 804, the administration server 104 receives, from mentors 112, mentor responses to the mentor compatibility queries.

At step 806, the administration server 104 receives, from mentees 110, mentee responses to the mentee compatibility queries.

At step 808, the administration server 104 creates mentor and mentee profiles using the mentor responses and mentee responses respectively. The profiles include like compatibility parameters based upon the responses.

At step 810, the administration server 104 determines a recommended mentor 112 to the mentee 110 by matching compatibility parameters in the mentor and mentee profiles which provides a useful technical effect, with the recommended mentor 112 having the greatest number of matching compatibility parameters with the mentee 110 when compared with the other mentors 112.

At step 812, the administration server 104 recommends the mentor 112 to the mentee 110 for engagement, using the mentor responses and the mentee responses.

At step 814, the administration server 104 receives engagement confirmation of the recommended mentor 112 by the mentee 110.

The foregoing method is suitable for matching a wide range of service providers with their clients. In this manner, organizations would need to adjust their recruitment strategy to employ service providers that suit their actual client base, rather than the other way around.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. An online mentoring tool configured to:
assign a goal to be performed by a mentee at a promotional level;
receive, from a mentor, scoring of the mentee in achieving the goal; and
promote the mentee to a higher promotional level using the scoring.

2. An online mentoring tool as claimed in claim 1, further including:
a searching tool to enable the mentee to search for the mentor from a number of possible mentors, irrespective of location; and
an inbuilt video chat tool to facilitate communication during sessions between the mentor and mentee, without the need to travel to a common location.

3. An online mentoring tool as claimed in claim 1, further including a recommendation tool to recommend the mentor to the mentee.

4. An online mentoring tool as claimed in claim 3, wherein the mentoring tool is configured to recommend the mentor for engagement to the mentee based upon mentor responses and mentee responses to respective mentor compatibility queries and mentee compatibility queries.

5. An online mentoring tool as claimed in claim 4, wherein the tool is configured to receive, from mentors, the mentor responses to the mentor compatibility queries.

6. An online mentoring tool as claimed in claim 4, wherein the tool is configured to receive, from the mentee, the mentee responses to mentee compatibility queries.

7. An online mentoring tool as claimed in claim 4, wherein the recommendation is determined using a mentor profile and a mentee profile created using the mentor responses and the mentee responses respectively.

8. An online mentoring tool as claimed in claim 7, wherein the recommendation is determined by matching parameters in the mentor profile and the mentee profile, with the recommended mentor having the greatest number of matching parameters with the mentee when compared with other mentors.

9. An online mentoring tool as claimed in claim 3, wherein the recommendation tool recommends the mentor to the mentee based upon personality or other profile features.

10. An online mentoring tool as claimed in claim 1, further including a company reporting tool for generating reports including goal details relating to the mentee or other mentees that are employees of a company.

11. An online mentoring tool as claimed in claim 1, further including a competition tool for enabling mentors to compete with each other.

12. A service provider engagement method involving the steps of electronically:
receiving service provider responses to service provider compatibility queries; and
receiving, from a client, client responses to client compatibility queries; and
recommending a service provider for engagement by the client using the service provider responses and the client responses.

13. An online service provider engagement method as claimed in claim 12, further involving recommending the service provider, from a plurality of service providers, to the client.

14. An online service provider engagement method as claimed in claim 13, wherein the service provider is recommended for engagement to the client based upon the service provider responses and the client responses to respective service provider compatibility queries and client compatibility queries.

15. An online service provider engagement method as claimed in claim 14, further involving receiving, from the plurality of service providers, the service provider responses to the service provider compatibility queries.

16. An online service provider engagement method as claimed in claim 14, further involving receiving, from the client, client responses to client compatibility queries.

17. An online service provider engagement method as claimed in claim 14, wherein the recommendation is determined using a service provider profile and a client profile created using the service provider responses and the client responses respectively.

18. An online service provider engagement method as claimed in claim 17, wherein the recommendation is determined by matching parameters in the service provided profile and the client profile, with the recommended service provider having the greatest number of matching parameters with the client when compared with other service providers.

19. An online service provider engagement method as claimed in claim 13, wherein the recommendation recommends the service provider to the client based upon personality.

20. An online service provider engagement method as claimed in claim 12 further involving the step of the client engaging the recommended service provider.
